(19) United States
(12) Patent Application Publication
(10) Pub. No.: US 2024/0054467 A1
(43) Pub. Date: Feb. 15, 2024

(54) Method and System for Transaction Processing

(71) Applicants: Edgar Jozef Beere, Nieuw Vennep (NL); SPAARNESTAD HOLDING N.V., Willemstad (NL)

(72) Inventors: Edgar Jozef Beere, Nieuw Vennep (NL); Ronald Adré Wever, Nieuw Vennep (NL); Johannes André Burg, Nieuw Vennep (NL)

(21) Appl. No.: 18/268,886

(22) PCT Filed: Dec. 21, 2021
(86) PCT No.: PCT/NL2021/050779

§ 371 Date: Jun. 21, 2023

(30) Foreign Application Priority Data
Dec. 21, 2020 (NL) 2027193

(51) Int. Cl. G06Q 20/20; G06Q 20/40; G06Q 20/04

(52) U.S. Cl. CPC G06Q 20/202; G06Q 20/401; G06Q 20/047

(57) ABSTRACT

The present invention relates to a method for processing of a payment transaction by means of a processing (finalization) computer system (2), such as a payment transaction system, such as a credit card transaction system arranged at a credit card organization, arranged for processing of the payment transaction, such as a credit card payment transaction, initiated at a POS system (3), such as arranged at a merchant, the method comprising steps of: —processing of payment transaction information, such as comprising an amount to be paid with respect to the transaction, from the POS system (3), such as from a transaction module thereof, —receiving of authentication information (140) with respect to the transaction, from the POS system (3), —transmitting (174) of authorization confirmation information relating to a confirmation of an authorization of the transaction to the POS system (3), characterized by steps for: —receiving (142), such as by means of a data assembly receipt module such as by means of a process executed on a processing unit, of a data assembly comprising specification information relating to the transaction from the POS system (3).

The present invention relates to a method and system for processing by means of a computer system, such as a payment transaction system, such as a credit card transaction system arranged at a credit card company, arranged for processing of a payment transaction, such as a credit card payment transaction, of the payment transaction coming from a POS system. Furthermore, the present invention relates to a method and system for by means of a POS system processing of a payment transaction with a computer system, such as a payment transaction system, such as a credit card transaction system arranged at a credit card company, arranged for processing of a payment transaction, such as a credit card payment transaction, of the payment transaction for transmitting to the computer system. Furthermore, the present invention relates to a system and method for by means of a cardholder processing system processing of a payment transaction with a computer system, such as a payment transaction system, such as a credit card transaction system arranged at a credit card company, arranged for processing of a payment transaction, such as a credit card payment transaction, of the payment transaction for transmitting to the computer system.

The present invention relates to the following contacts. In the present document, the term merchant is used for an entity such as a company debt sells goods or services to a consumer and to that and uses a payment service provider such as is relevant for the present invention, such as a credit card company. To this end, a merchant is provided with a payment transaction module for the purpose of a payment transaction that is in communication with a payment transaction system of the payment service provider. Furthermore, the merchant is provided with a cash register device or an invoicing system for compiling of a transaction documents such as a receipt or an invoice. Furthermore, the merchant applies in authentication or authentication input in the form of authenticating of card data by the consumer by means of a card reader, such as by means of pin authentication, or by means of an input module for inputting of authentication data, such as card a tachometer, such as comprising a so-called CVC code with which the consumer provides in authentication with respect to a payment for the purpose of an underlying transaction. Such a card reader is arranged for physical contact with the card or for wireless contact with the card in ways that are per se known, such as by means of a magnetic stripe or chip. The payment transaction including the authentication as provided by the consumer is subsequently mostly subject to an authorization by the payment transaction system of the payment service provider. A cardholder within the understanding of the present invention is to the party that has the payment agreement with the payment service provider. In practice, the cardholder provides the card for example to a third-party holder, such as an employee, relation or child, such that the third-party holder may perform transactions in the name of the cardholder.

Within this context, the inventor recognized as a disadvantage that payment transactions that are performed by the third-party holder are to be checked and to be administratively processed. With this, the inventor also recognized as a disadvantage that such a check is mostly performed after the transaction. With regard to the administrative processing, the present inventor recognized that this is a time consuming or labor-intensive work.

In order to obviate such disadvantages, the present invention provides a method for processing of a payment transaction by means of a processing (finalization) computer system (2), such as a payment transaction system, such as a credit card transaction system arranged at a credit card organization, arranged for processing of the payment transaction, such as a credit card payment transaction, initiated at a POS system (3), such as arranged at a merchant, the method comprising steps of:
processing of transaction information, such as comprising an amount to be paid with respect to the transaction, from the POS system (3), such as from a transaction module thereof,
receiving of authentication information (140) with respect to the transaction, from the POS system (3),
transmitting (174) of authorization confirmation information relating to a confirmation of an authorization of the transaction to the POS system (3), characterized by steps for:
receiving (142), such as by means of a data assembly receipt module such as by means of a process executed on a processing unit, of a data assembly comprising specification information relating to the transaction from the POS system (3).

Such a method according to the present invention provides as advantage that the computer system that serves the purpose of processing of transactions with the payment service provider such as the credit card company is provided with the possibility to receive the data assembly, such as by means of a data assembly receipt module, such as preferably integrated into the computer system, such as in a transaction processing module thereof and/or the data assembly parsing module thereof such that the data assembly comprising the specification information with respect to the transaction from the POS system may be received or processed. With this, it is advantageously achieved that the authorization that the POS system requires as acceptance of the payment at the side of the payment service provider may be based on at least a part of the data assembly, while according to the prior art, such acceptance cannot be based on the data assembly because the data assembly does not exist. Further preferably, according to the present invention, it is achieved that the computer system may make this information available to the cardholder via the computer system, such as the payment transaction system of the payment service provider of the transaction, such that the cardholder may make use of this data. It is a further advantage that the cardholder, upon processing by the processing system of the payment service provider, may directly have this data underlying the transaction, while according to the prior art, the only information for the purpose of an account statement was available, such as transaction amount, exchange rate when applicable, name of merchant and date.

According to the prior art, such information provided in the form of a receipt or invoice to the third-party holder by contacting the physical card with the POS system. Him and the computer system, or the payment transaction system, according to the prior art is not equipped to receive 4 process such information. Subsequently, the third-party holder e.g. had to input such data into a declaration system of the cardholder. This known way of handling declarations thanks a lot of time on the part of the third-party holder as well as on the part of the cardholder.

By means of a system according to the present invention, the cardholder may be provided with the underlying transaction data in an automated manner and directly in combination with the transaction data, such as the invoice lines of the services and products to be authorized. With this, the cardholder may for example determine whether a price of an underlying purchase is acceptable. A cost declaration system may our firm be set up and used in a much more efficient way on the basis of such combined supply of information to the cardholder processing system.

According to a first preferred embodiment according to the present invention, the method comprises steps of parsing (152), such as by means of a data assembly parsing module (26), of the data assembly comprising a specification information (76) with respect to the transaction from the POS system (3). Such a transaction device is usually designed as a separate device, comprising a part in which usually a card reader is comprised, as a module in a combined device, or as an application in a computer device. By means of the transaction device, the POS system connects with the computer system of the payment service provider, such as a data communication module, a transaction processing module, and/or a data assembly parsing module thereof. It is an advantage of the present invention that with this, the computer system of the payment service provider is configured for receiving of the data assembly from the transaction device. The data assembly parsing module is preferably configured by means of an adaptation of a usable POS system, such as a payment terminal thereof, such as by means of an extension of functionality in software.

Preferably, such a preferably embodied as software extension of the functionality of the transaction module provides an extension of sending options, comprising the option of adding at least a transaction
our product line as comprised in the data assembly to the transaction upon transmission thereof.

In an alternative manner, of the method, the steps for receiving or parsing of the data assembly comprise steps of receiving of the data assembly from a transaction module or a data assembly compile module (38), of the POS system. Here, for example, a direct alternative communication of the data assembly from the POS system or invoicing system to the data assembly parsing module is provided. According to the embodiment, processing of the data assembly by the transaction device is thus otherwise achieved. This is advantageous, for example, in the case of a relatively large data assembly leading to a relatively large data transport between the transaction device and the computer system compared to the prior art.

In relation to the invention in general and in relation to the preferred embodiments, more specifically, it is achieved that for functioning of such systems while applying the present invention, such systems are preferably adapted in order to obtain the capability to assemble the data assembly and sending thereof suitable for receipt by the computer system.

According to a further preferred embodiment, the method comprises data assembly authorization steps (154) based on at least a part of the data assembly providing an authorization grant or an authorization denial, preferably comprising steps of compiling of the authorization confirmation information, such as by means of a data assembly authorization module (28), in case of granting of authorization on the basis of on the data assembly. An advantage of such embodiment is that the final authorization by the computer system is not only performed in ways that are per se known, based on general information relating to the transaction, such as relating to data pertaining to the cardholder, third-party holder, merchant, location, time of day, time since previous transaction, difference in distance since previous transaction, etc., but that this authorization may now also be based on information relating to the content of the transaction, such as price of the product, price of a surface, category of a product, category of a service, time of purchase of a service, classification of a service. With this, excessive costs may be prevented at the time of authorization of the transaction thereof. In an alternative manner, such excessive costs may for example be authorized negatively in case of a, e.g. time related, preventability and authorize positively in case of a, e.g. time related, necessity.

With this, it is for example considered that booking of an excessively expensive hotel room is refused in case of availability of time to perform such a booking in an alternative manner. In case of for example a booking in the course of an evening of a single overnight stay, this may be considered as unavoidable and based on that is assessed as unavoidable. With this, by means of such a preferred embodiment, it may be realized that based on information of the data assembly that is available according to the present invention, the functioning of the automated authorization by the computer system may be improved by having the automated system generate another outcome based on the content of the data assembly that is transferred during the transaction.

According to a further preferred embodiment, the method comprises steps for, such as by means of the data assembly authorization module, performing of the data assembly authorization steps based on at least a part of the data assembly, on the basis of decision rules. Such decision rules may be included in the data assembly authorization module or retrieved by the data assembly authorization module from a data store while the transaction is being performed. With this, and automated authorization may be realized in a further advantageous manner, such as during performing of a payment transaction or an authorization transaction wherein the payment and/or the authorization is performed in an automated manner during performing of the transaction.

Further preferably, the method comprises steps of transmitting of the payment transaction information and preferably the data assembly to a cardholder processing system (4), such as received from the POS system or such as parsed by means of a data assembly parsing module (26) of the computer system. With this, it is advantageously achieved that the cardholder processing system, during performing or executing of the transaction may be provided with this information, as a result of which it is additionally provided with the data assembly in addition to the transaction data according to the prior art. With this, the cardholder processing system is de facto provided with invoice data or even the entire invoice, including data relating to the Merchant, the dating, invoice lines relating to products and services underlying the transaction. With this, the cardholder processing system is provided with all data required to function as a declaration system for a declaration of costs related to the invoice. In these data are directly originating from and related to the transaction of which the products and services are underlying, such embodiment advantageously provides a check of a declaration of such costs by a third-party holder, such as an employee of the cardholder.

Furthermore, a cardholder processing system with the data of the data assembly is provided with relevant information that may be checked for approval ability of the, by means of an authorization of an authorization transaction authorize able or by means of a payment of a payment transaction payable, products or services that are underlying to the transaction.

For the purpose of processing such authorization as executed by the cardholder processing system, according to a further preferred embodiment, the method comprises steps of receiving, such as by means of a data assembly authorization module (28), of a cardholder transaction authorization of the transaction based on the transaction information and/or the data assembly from the cardholder processing system (4), preferably from a cardholder authorization module (48) thereof. With this, the computer system is capable of having such an authorization performed by the cardholder processing system or to be able to process it. With this, it is advantageously realized that, such as with performing of a transaction, such as for authorizing of the transaction or for transmitting of an authorization by the computer system to the POS system, to have a further authorization performed by the cardholder processing system and to receive the result thereof such that it becomes possible for a cardholder to effectively in real time approve or deny a transaction. With this, the cardholder is effectively capable to approve or disapprove a declaration of expenses before performing of the transaction.

According to a further preferred embodiment, the data assembly is functional as a proof of access, such as a ticket, such as for access to a concert, transport, such as a train or plane. With this, it is advantageously realizable that the cardholder may be provided with a technical token, such as a QR code or a numerical code, for this functionality in for example his mobile phone or watch from preferably the cardholder system.

Further preferably, for the purpose of the method, the data assembly is functional as proof of access to spaces, services or as a further resource. With this, it is advantageously realizable that the cardholder may be provided with a technical token, such as a QR code or a numerical code, for this functionality in for example his mobile phone or watch from preferably the cardholder system.

Further preferably, the data assembly is functional as a proof of warranty, proof of ownership, proof of insurance, a proof of delivery in parts and/or on call for the purpose of the method. With this, it is advantageously realizable that the cardholder may be provided with a technical token, such as a QR code or a numerical code, for this functionality in for example his mobile phone or watch from preferably the cardholder system.

Further preferably, for the purpose of the method, the data assembly is functional as an input for a process step of a series of processing steps, such as in a block chain process. With this, it is advantageously realizable that the cardholder may be provided with a technical token, such as a QR code or a numerical code, for this functionality in for example his mobile phone or watch from preferably the cardholder system.

Further preferably, for the purpose of the method, the data assembly is functional for a company purchasing transaction, such as by means of a purchasing card. With this, it is advantageously realizable that the cardholder may be provided with a technical token, such as a QR code or a numerical code, for this functionality in for example his mobile phone or watch from preferably the cardholder system.

A further aspect according to the present invention relates to a method for processing by means of a POS system (3) of a payment transaction with a computer system (2), such as a payment transaction system, such as a credit card transaction system arranged at a credit card company, arranged for processing of the transactions, such as a credit card payment transaction, of the payment transaction for transmitting to the computer system (2), the method comprising steps of:
transmitting of transaction information, such as comprising an amounts to be paid with respect to the transaction, from the POS system (3),
transmitting of authentication information with respect to the transaction from the POS system (3),
receiving of confirmation information with respect to a confirmation of an authorization of the transaction to the POS system (3), characterized by steps of:
compiling, such as by means of a data assembly compile module of a data assembly comprising specification information relating to the transaction of the POS system (3).

This aspect according to the present invention provides the implementation of the concept of the invention at the side of the POS system by means of the steps for compiling of the data assembly, such as by means of a data assembly compiling module that is comprised in the POS system to this end. With this, in an advantageous manner, the input in the shape of the data assembly is provided based on which the computer system of the payment service provider may receive the same. As further explanation of a further advantage thereof, reference is made to the explanation of the advantages relating to the preceding aspect according to the present invention. The authentication information relates to information on the basis of which the computer system may identify and authenticate the cardholder or third-party holder. Depending on a type of authentication that is applied, the authentication is performed in the POS system, such as by means of a card reader onto which the cardholder or third-party holder for example enters a pin code, or authentication is performed on the basis of a further primary and/or secondary way of authentication, such as per se known in the prior art. The authentication information, such as confirmation of the authentication, such as comprising information that shows that the cardholder performs an authentication, is sent from the POS system to the clearing computer system.

According to a preferred embodiment, the steps of transmitting of the data assembly comprise steps of transmitting of the data assembly from a transaction module or the data assembly compile module of the POS system (3) to the computer system (2), such as by means of a data assembly receiving module thereof. With this, the method provides similar advantages as described relating to the preceding aspect.

Further preferably, the method provides at the side of the POS system that the steps of transmitting of the data assembly comprise steps of transmitting of the data assembly from a cash register device or invoicing system (5) of the POS system (3) to the computer system (2). With this, the embodiment provides similar advantages as described in relation to the preceding aspect.

The compiling is preferably performed in the POS system in the data assembly compiling module thereof. Alternatively, a variance of the cash register system or invoicing system is configured for performing of such steps for compiling of the data assembly. A hybrid solution in which for example the cash register device formats or preformats data for the purpose of compiling of the data assembly, to a straightforwardly recognizable and copyable format is herewith provided.

Advantageously, a further preferred embodiment preferably provides that the compiling steps provide information with respect to elements of the purchase of products and/or services underlying to the transaction in a predetermined data format, such as in a substantially character-based format HTML, XBRL, SWIFT, ASCII, CSV, PDF, or in a substantially graphically based format such as JPG or TIFF. It is advantageous when a POS system may function in a system according to the present invention with as little adjustments as possible. It is there with further advantageous deficits adjustments may be realized with existing hardware of an existing POS system. With this, it is provided that the respective computer system of a payment service provider is capable of processing a variety of performance of the data assembly.

In an alternative manner, the said data store is configured for transforming of a supply format of the data assembly from the POS system to a supply format of the data assembly suitable for the respective computer system of the payment service provider. Alternatively, it is provided that each POS system compiles the data assembly in a standardized information format. Such a standardized information format is preferably optimized for maximum speed for processing thereof in the computer system of the payment service provider or for fulfilling a data standard that is suitable for further processing by the computer system of the payment service provider or by a respective cardholder processing system of the cardholder.

This consideration of the inventor brings the description to the following aspect according to the present invention, that is directed at a method method for processing by means of a cardholder processing system (4) of a payment transaction with a computer system (2), such as a payment transaction system, such as a credit card transaction system arranged at a credit card company, arranged for processing of the payment transaction, such as a credit card payment transaction, of the transaction for transmitting to the computer system (2), the method comprising steps of:
receiving of payment transaction information, such as comprising an amount to be paid with regard to the transaction, from the computer system (2), characterized by:
receiving (160), such as by means of a data assembly receipt module, such as by means of a process executed on a processing unit, of a data assembly comprising specification information relating to the transaction.

This aspect according to the present invention provides the embodiment of the concept of the present invention at the side of the cardholder, especially the cardholder processing system thereof, by means of the steps for sending of the data assembly such as by means of a data assembly sending module that is to this end comprised in the POS system. Further advantages thereof are described in relation to above aspects.

Further preferably, the method according to this aspect comprises steps for receiving of a data assembly comprising specification information with respect to the transaction from the computer system or the POS system.

Further preferably, the method according to this aspect comprises data assembly authorization steps (166), such as by means of the cardholder authorization module (48), based on at least a part of the data assembly providing an authorization grant or authorization denial, preferably comprising steps of compiling of the confirmation information in case of granting of the authorization based on the data assembly. Further preferably, in method according to this aspect comprises steps of performing the cardholder authorization steps and/or the data assembly authorization steps based on at least a part of the data assembly based on decision rules. This aspect provides the advantage that the authorization may be given while the card or older or third-party holder performs the transaction at the POS system. With this, the cardholder processing system provides an immediate authorization for the transaction processing in real-time or in similar real-time as the per se known authorization of a per se known payment transaction by means of a per se known bank card.

A further advantage of a method according to the present aspect relates to an actual authorization on the basis of the contents of the data assembly and with that on the basis of data relating to the products or the services forming the transaction by the cardholder processing system of the cardholder itself. This is especially advantageous in case of a third-party holder the performs transactions based on an agreement with the cardholder. With this, absolutely too expensive or relatively too expensive transactions may be prevented at the moment engaging into the transaction, that is, an authorization may be denied which is similar to the POS system or the merchant with regards to the effect as a denial of an authorization by a credit card company.

A further aspect according to the present invention relates to a computer system (2), such as a payment transaction system, such as a credit card transaction system arranged at a credit card company, arranged for processing of a payment transaction, such as a credit card payment transaction, for processing (finalizing) of the payment transaction from a POS system (3), such as arranged with a merchant, the computer system (2) comprising:
at least one processing unit arranged for data processing,
at least one data store for storage of instructions and/or data,
a receipt module arranged for receiving of payment transaction information, such as comprising an amount to be paid with respect to the transaction, from the POS system (3),
a receipt module arranged for receiving of authentication information with respect to the transaction, from the POS system (3),
a transmit module arranged for transmitting of authorization information with respect to an authorization of the transaction to the POS system (3), characterized by:
a data assembly receipt module, such as a process performed on a processing unit, for the purpose of receiving (142), for receiving of a data assembly comprising specification information with respect to the transaction from the POS system (3). By means of such a computer system, with application of the data assembly, similar advantages are achieved as described in relation to the first aspect.

According to a preferred embodiment, such a computer system comprises a data assembly parsing module (26) arranged for parsing of a data assembly comprising the specification information with respect to the transaction from the POS system (3).

Further preferably, such a computer system comprises a data assembly authorization module for performing of data assembly authorization steps providing grounds of an authorization or a denial of an authorization based on at least a part of the data assembly, preferably on the basis of decision rules.

Further preferably, such a computer system according to this aspect comprises at least one module that is further configured for performing of steps according to the first aspect of the present invention.

A further aspect according to the present invention relates to a POS system (3) for processing of a transaction with a computer system (2), such as a payment transaction system, such as a credit card transaction system arranged at a credit card company, arranged for processing of a payment transaction or an authorization transaction, such as a credit card payment transaction, for transmitting to the computer system (2), comprising:
a transmit module arranged for transmitting of payment transaction information, such as comprising an amount to be paid with respect to the transaction, from the POS system (3),
a transmit module arranged for transmitting of authentication information with respect to the transaction, from the POS system (3),
a receipt module device for receiving of confirmation information with respect to a confirmation of an authorization of the transaction to the POS system (3), characterized by steps of:
a data assembly compile module arranged for transmitting of a data assembly comprising specification information with respect to the transaction from the POS system (3).

Further preferably, in such a POS system according to the present invention the transmit module arranged for transmitting of the payment transaction information and/or the transmit module arranged for transmitting of authentication information are a component or function of a payment terminal.

Further preferably, such a POS system according to the present invention comprises a module that is arranged for performing of steps according to the second above aspect according to the present invention.

A further aspect according to the present invention relates to a cardholder processing system (10) or cardholder authorization system for processing of a payment transaction with a computer system (2), such as a payment transaction system, such as a credit card transaction system arranged at a credit card company, arranged for processing of the payment transaction, such as a credit card payment transaction, for transmitting to the computer system (2), comprising:
a receipt module arranged for receiving of payment transaction information, such as comprising an amount to be paid with respect to the transaction, from the computer system (2), characterized by:
a data assembly receipt module, such as a process executed at a processing unit, for the purpose of receiving (162) of a data assembly comprising specification information with respect to the transaction from the computer system (2) and/or the POS system (3).

According to a preferred embodiment, such a cardholder processing system (10) comprises at least one cardholder authorization module (48) for executing of data assembly authorization steps (166) providing an authorization grant or an authorization denial based on at least a part of the data assembly, preferably executed based on decision rules.

Further preferably, such a computer system according to this aspect comprises at least a module that is further configured for performing of steps according to the first aspect according to the present invention.

A further aspect according to the present invention relates to a data message generated with application of a method for processing of a payment transaction by means of a POS system (3), the data message comprising transaction information with respect to the payment transaction, such as a payment transaction or authorization transaction for execution thereof by a computer system (2), such as a payment transaction system, such as a credit card transaction system arranged at a credit card company, arranged for processing of the payment transaction, such as a credit card payment transaction, the method comprising steps of:
processing of transaction information, such as comprising an identification of a cardholder and an amount to be paid with respect to the transaction, preferably combined with a transaction date,
compiling of a data assembly comprising specification information with respect to the transaction,
assembling of the data message comprising the transaction information at the data assembly in a format suitable for receipt by the computer system (2).

This aspect provides advantages according to the present invention as those that are indicated in relation to above aspects according to the invention. Such a data message provides as advantage that with application thereof, communication between a POS system and the computer system such as according to the present invention may be embodied in an advantageous manner.

According to a preferred embodiment, the data message is further compiled with application of method steps for gathering authentication information with respect to the transaction as well as steps for adding of the authentication information to the data message. By means of including such authentication information in the data message, it is advantageously achieved that all the data elements in a database may be transmitted between the POS system and the computer system. With this, the mutual relation between these data elements may advantageously be determined or verifiable as these are part of a message. Even while the mutual relation between these data elements is verifiable by means of multiple data messages, combination thereof in a data message provides advantages that are clearly understandable to the skilled person.

Further preferably, the steps for assembly of the data message comprises steps for: forming of the data message to a standard for payment transaction communication with a payment terminal. With this, it is advantageously achieved that the data message conforms to existing standards of communication or communication protocols that are per se known within the technical field of such payment systems, such as that existed before defining of this invention.

Further advantages, features and details of the present invention will be further elucidated on the basis of a description of one or more preferred embodiments with reference to the accompanying figures. Similar yet not necessarily identical parts of different preferred embodiments may be indicated with the same reference numerals.

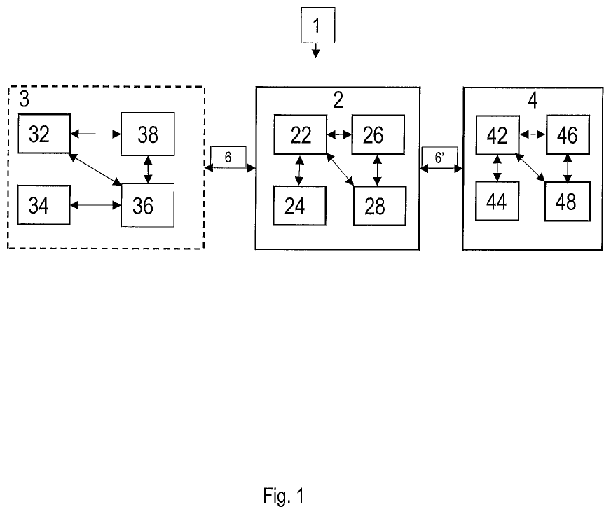

FIG. 1 relates to a schematic representation of a system according to a preferred embodiment according to the present invention.

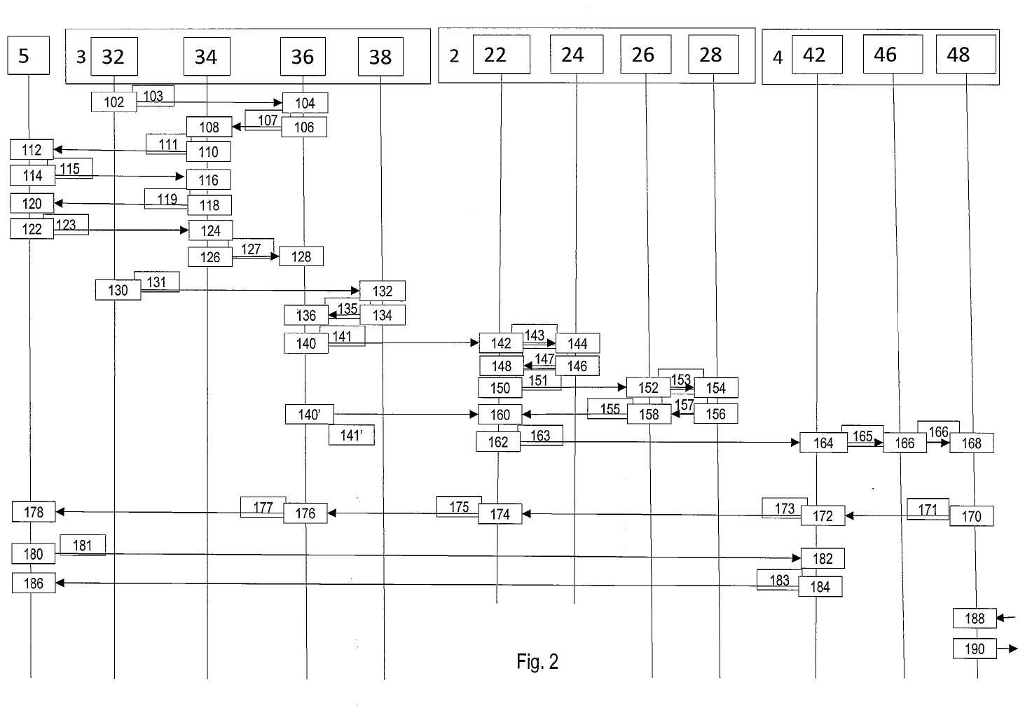

FIG. 2 relates to a schematic representation of a method by means of a system according to a preferred embodiment according to the present invention.

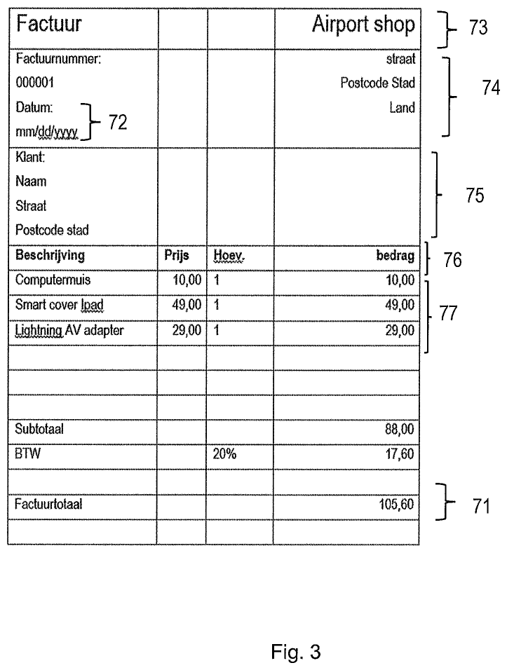

FIG. 3 relates to a schematic representation of a representation of information processed according to preferred embodiments according to the present invention.

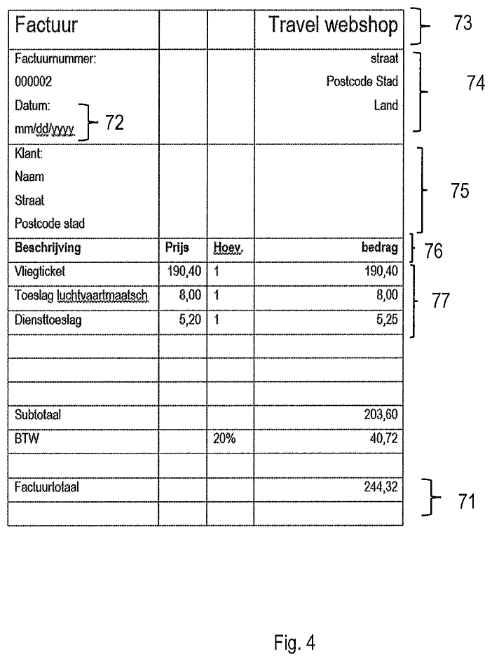

FIG. 4 relates to a schematic representation of a representation of information processed according to preferred embodiments according to the present invention.

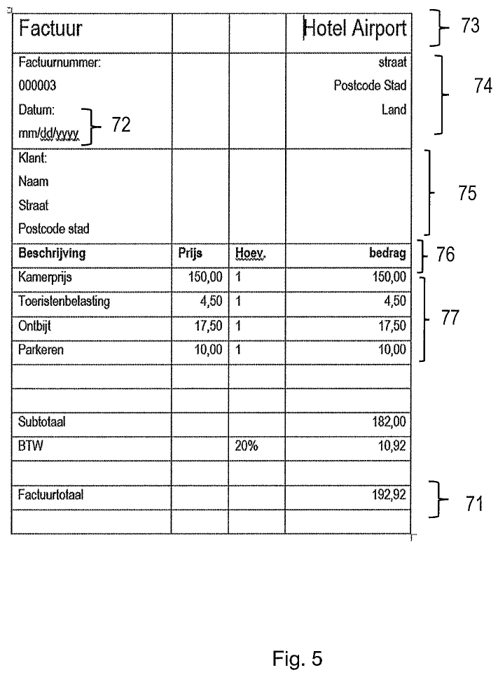

FIG. 5 relates to a schematic representation of a representation of information processed according to preferred embodiments according to the present invention

A first preferred embodiment (FIG. 1) according to the present invention relates to a computer system to that is configured for processing of a transaction, such as a payment transaction or an authorization transaction, such as a credit card payment transaction, wherein the computer system to is embodied or applicable in practice as a payment transaction system such as a credit card transaction system. With this, the computer system 2 is part of a general transaction system 1 wherein the computer system to communicates with a POS system 3, and depending on the implementation of a preferred embodiment optionally with a cardholder system 4.

The POS system 3 is a system that functions within a technical environment of a merchant. A merchant is a party that wants to perform a transaction that is a transaction within the understanding of the present invention, such as a payment transaction or an authorization transaction. The POS system comprises in general terms a payment terminal 46 for safe communication with the computer system, as well as a cash register device or invoicing system 32 and an authentication module 34.

During execution of a transaction, there is current communication between the POS system 3 and the computer system 2. In general terms, the POS system transmits transaction information to the computer system and transmits the computer system a confirmation thereof to the POS system based on which the transaction is confirmed to both the merchant of the POS system as the cardholder or the third-party holder. The computer system 2 is a system that functions within a technical environment of the payment transaction service provider. Such a computer system has a communication module for receiving transaction information from the POS system. According to the invention or preferred embodiments thereof, it also comprises a data assembly receiving module which makes the computer system suitable for receiving the data assembly. Furthermore, the data assembly receiving module preferably functions to parse and/or process the data assembly so that it may be used for method steps of the present invention or preferred embodiments thereof. The data assembly receiving module is preferably designed as a functional unit by means of, for example, a software implementation.

The computer system 2 further comprises a processing unit 22 with memory for further functional implementation of the computer system. Furthermore, the computer system 2 comprises a data assembly authorization module 28 for performing data assembly authorization steps. Examples of these are described below. The computer system further comprises a database for storing information resulting from the method according to the invention or preferred embodiments thereof. According to a straightforward example in the context of a credit card issued by a credit card company to a cardholder, possibly for the benefit of a third party holder, a Merchant is a party in need of payment or authorization of, for example, a later payment. A Merchant is therefore the only selling or payment receiving party. A Merchant has an agreement with the credit card company in order to receive such payments or authorizations. To this end, the Merchant's POS system at the credit card company always sends a relevant transaction, such as by means of transaction information or according to a more specific embodiment, payment transaction information, to the computer system 2 so that the computer system 2 may process the transaction, such as through authorization and execution.

Executing such a transaction by the computer system 2 comprises, for example, debiting or reserving the respective transaction amount from a respective account of the cardholder, as linked to the respective third-party holder. Carrying out such a transaction furthermore comprises, for example, crediting the respective amount to a respective account of the Merchant.

The authorization of such a transaction is done by means of data received in the transaction information, such as authentication data, contained therein. Such authentication data concern, for example, an authentication by means of a card reader 34 based on a transaction card (not shown), such as a credit card, debit card or bank card, wherein the card holder or third-party holder enters a pin code associated with the card for authentication. A resulting authentication confirmation is added to the transaction information transferred from the POS system 3 to the computer system 2. Such modes of operation are well known in the art. Authentication during a payment transaction takes place, for example, in the usual manner by reading card data by means of a card reader, on the basis of which a card holder or third-party holder is prompted to enter a pin code into the card reader. On the basis of the pin code, the card reader authenticates the cardholder or third-party holder as having been authenticated to perform a transaction using the card. Such a card reader 34 is highly secured with card data not leaving the secure portion of the card reader and the data related to the PIN code is fed to this secure portion directly from the user interface of the input.

The computer system 2 further performs prior art authorization steps. Such authorization steps relate in particular to the prevention of fraud. Different implementations of different credit card systems have very advanced algorithms for preventing positive authorization in case of fraudulent transaction attempts. Examples of such algorithms are based on historical transactions or historical transaction behavior, geographic locations of transactions such as in addition to geographic location related to a time, or a pattern in times of such transactions. Such authorization algorithms are beyond the scope of the present invention. In addition, the present invention provides additional authorization steps which are additional to the authorization steps mentioned herein, which are known per se.

In addition to the prior art, the computer system 2 and the POS system 3 have additional features including sending additional information, which may preferably be included in per se known messages with which transaction information that is sent from the POS system 3 to the computer system 2 is transferred during the execution of a transaction.

Such additional information relates to a data assembly contemplated as part of the present invention. The data assembly is compiled at the location of or by the POS system 3, such as on the basis of information from the checkout device or billing system 32. It is hereby provided that the data assembly is compiled by either the checkout device or billing system. 5, or a payment terminal or credit card payment terminal 36 thereof, which, in addition to the prior art for the purposes of the present invention, includes a data assembly transmission module or data assembly transmission function. Such a data assembly transmission module or data assembly transmission function is, of course, unknown in the art.

Transaction information known per se used in the prior art as part of a message including the transaction information is an amount, a date with time, relevant data relating to the cardholder and/or third party holder, and preferably relevant data relating to the Merchant, whereby the Merchant is also identifiable by the POS system configured for use by the Merchant. It is therefore a feature of the present invention to provide the data assembly to or have it received by the computer system in addition to this per se known transaction information.

The computer system 2 according to the present invention comprises, for example, a function performed as a function of the processing module of a data assembly receiving module or function adapted to receive the data assembly according to the present invention. Furthermore, the computer system 2 comprises a data assembly parsing module 26 adapted to extract or extract the data assembly from a message containing the transaction information or from a separate message containing the data assembly in addition thereto.

The data assembly receiving module is preferably integrated in the processing unit 22 or a receiving module functioning therein for communication with the POS system 3, such as with the payment terminal 36 thereof. Such communication takes place via a communication path 6. The communication path 6 may be implemented in many ways in a manner known per se. An example thereof is that the communication path is from a computer network or communication network to which the POS system or its payment terminal 36 is connected, through an intermediate network such as the Internet, and from the computer system side from a computer network or communication network through which the computer system is connected. Alternatively, a direct telephone convection is possible, such as via a switched telephone network.

The computer system 2, such as preferably the processing unit thereof, is further provided with a data assembly transmission module or function for transmitting the data assembly to a cardholder processing system 10 of a cardholder.

This advantageously achieves that the data assembly may be received by the computer system 2, stored or processed there. This also advantageously achieves that the data assembly may be forwarded to the cardholder system 4 so that the cardholder system 4 may process the data assembly. The cardholder system 4 is therefore advantageously provided with underlying content of a transaction. Such underlying content of the transaction is, for example, a collection of records reflecting the content of the transaction. Such underlying content of the transaction concerns, for example, invoice lines of an invoice relating to the underlying transaction. In this way it is advantageously realized that the cardholder system may be provided with such billing data directly with the transaction data according to the prior art.

It is thus advantageously realized that the cardholder system no longer needs to be provided with the invoice by the physical cardholder or third party for the purpose of processing such billing data. As a result, the processing of an invoice by a cardholder or a processing of the declaration based on such an invoice may be handled directly on the basis of the data assembly as provided according to the present invention with transaction data according to the state of the art.

In addition, the data assembly provides the cardholder with the option of authorization based on the content of the data assembly. By means of implementation of such an authorization on the basis of, for example, decision rules, such authorization is automated according to a suitable preferred embodiment and may be realized in real time of the transaction. Such an authorization based on the data assembly provides the advantage that the cardholder may provide clarity during the execution of a transaction with regard to the acceptance of a transaction by the cardholder to a third-party holder. A transaction with a price up to a threshold is authorized and a transaction above the threshold is not authorized. As mentioned in this document, such a threshold value is preferably dependent on time parameters and/or location parameters, or for example urgency parameters such as an amount of time available between the transaction and the purchase of a service, such as a hotel stay or flight.

The cardholder processing system 4 of the cardholder preferably includes a processing unit 42 and a memory. Data related to the transaction and data related to the data assembly may be stored in a database 44 with processing means that are per se executable within a DBMS of the database 44. For the purpose of being able to authorize based on the data assembly the cardholder processing system 4 includes a cardholder data assembly parsing module 46, and a cardholder authorization module 48 configured to perform data assembly authorization steps by the cardholder processing system.

An example of an exemplary transaction, for example, relates to the purchase by a third party holder as an employee of a card holder of necessary consumables for functioning during a business trip in a point of sale at an airport, the “Airport shop”. Information provided in the prior art by the POS system 3 or its payment terminal 36 to the computer system 2 is directed to the amount to be paid, being the invoice total 71 and the date 72. The identity of the Merchant 73 is further of relevance, such as by means of the name and/or an identification number as known in the payment system 1 or the computer system 2 thereof. The data relating to this Merchant may be included in the transaction information as well or for verification.

The addition of the data assembly receiving module provides the ability for the computer system 2 to receive information contained in the data assembly which is not available in the prior art.

Use of the data assembly for authorization steps according to preferred embodiments of the present invention is directed to authorization based on information contained in the data assembly. Authorization may hereby be given or withheld on the basis of such data, whether or not in combination with information about the cardholder and/or third-party holder.

Examples provided for such authorization steps are focused on, for example, a maximum authorizable amount for a specific product or service. An authorization is given for a specific product or service when an amount is below a threshold value. The threshold value is provided according to the present invention as determined in relation to at least one authorization parameter.

Such an authorization parameter is, for example, a threshold amount for a hotel room, wherein the threshold amount is related to the third party holder. It is also provided that a threshold amount is related to the location of the hotel of the hotel room. In an ‘expensive’ city, for example, a more expensive hotel room may be authorized than one in a ‘cheap’ city. It is further provided that a hotel room may be authorized in the short term for a higher amount than in the longer term. It is also provided that a hotel room in an environment with a lot of business traffic and little tourist traffic may be authorized during a weekend for a lower amount than during the week. Conversely, it is envisaged that a hotel room in an environment with little business traffic and a lot of tourist traffic may be authorized during a weekend for a higher amount than during the week.

In an alternative manner, authorization parameters are conceivable for renting a car, wherein the authorization is given on the basis of, for instance, the daily price, free kilometer costs per kilometer, type of vehicle, location, day of the week, reservation term and/or combinations thereof.

Alternatively, authorization parameters are conceivable for product types, such as work-related products with a high use requirement, such as a replacement computer mouse, charger or adapter where a relatively high price for the product type may be authorized than in the case of products with a low use requirement, such as a sleeve or cover for a tablet.

Such examples also show the applicability of a preferred embodiment in a current payment transaction for a direct purchase of a product or service. For example, a direct purchase is a purchase at the time of execution of the payment transaction. Alternatively, a direct debit is a debit within a limit or a billing period associated with a limit of, for example, a credit card. An authorization usually cannot be given if a limit or a limit of such a period has been exceeded or the transaction is exceeded.

Alternatively, this shows the applicability of a preferred embodiment in a future payment transaction for a future purchase of a product or service, such as related to a future limit such as a future billing period. Such a future payment transaction is within the concept of such a preferred embodiment authorizable for a respective future limit related to a future period. An advantage of such a preferred embodiment is that a cardholder system may be provided with such information regarding future payment transactions. This allows the cardholder system to make such information available to relevant cardholder processing systems. According to such a preferred embodiment, current and future costs may hereby be made available in a system for tracking project costs of a card holder and/or third party holder. Providing such information to relevant cardholder systems is only possible on the basis of the information system according to the present invention.

FIG. 2 shows a schematic representation of a method and information flows according to a combined preferred embodiment of the present invention. In particular, it is noted that in this specification various aspects of the invention and preferred embodiments thereof are incorporated in this figure in combination. Certain method steps are performed in one aspect and preferred embodiments thereof by a computer system, such as in the first aspect. Certain further method steps according to one aspect and preferred embodiments thereof are performed by a POS system, such as according to the second aspect. Certain further method steps according to one aspect and preferred embodiments thereof are performed by a cardholder processing system, such as according to the third aspect.

In the following, a method is described according to a number of preferred embodiments of the present invention. Method steps of a POS system, method steps of the computer system two and method steps of a cardholder system 4 are described in relation to each other. These method steps are mutually assignable to various aspects of the present invention as well as preferred embodiments thereof.

In the event of an order for a service or a purchase of a product, a receipt or invoice is composed within a POS system 3 of a Merchant by a cash register 32 in a step 102. In the usual manner, by means of a message 103 the data relating to the amount to be paid are transmitted to a POS transaction module or payment terminal 36, which is coupled to a computer system of a credit card company, and received there in step 104. Based on this data, the payment terminal 36 requests for insertion of a credit card into a card reader 34 via step 106 and message 107. The card reader 34 receives the message 107 in step 108. In step 110, the card reader 34 outputs a request for a payment card or credit card through message 111 to the cardholder 5. The cardholder 5 inserts the card into the card reader, whereupon the card reader reads the card in step 116. In step 118, the card reader processes information from the card and outputs a message 119 to the user 5. This message 119 involves prompting the user to enter an authentication code such as a PIN code. In step 122, the user enters the authentication code 121 into the card reader. The card reader 34 processes the input at step 124. At a step 126, the card reader determines a positive authentication from the card and transfers it via message 127 to the POS transaction module 36. The POS transaction module 36 processes the positive authentication at step 128.

Said steps from 110 in the above, function in another preferred embodiment with an online POS system, such as from a web shop, ticket service or an internet travel agency, or a transaction between computers alternatively as follows. In step 110, an authentication module 34 of the on-line POS system sends an authentication request to a user's computer through message 111. The user's computer receives the authentication request in step 112, after which the user appropriately inputs the authentication information. This concerns, for example, data relating to a credit card. Such data relating to a credit card often comprise a so-called CVC code for detailed authentication. Next, the user's computer processes this data and transmits it in a message 115 to the authentication module 34. In step 116, the online authentication module 34 processes the authentication data of message 115.

If a secondary authentication is required, the authentication module 34 sends a secondary authentication message 119 to the user's computer for processing in step 120. The user performs steps related to the secondary authentication, such as authentication via a mobile phone or local card reader device in a manner known per se. Then, in step 122, the user's computer sends a message 123 to the authentication module 34 of the POS system. With the receipt in step 124 by the authentication module 34 of the POS system, the authentication is completed. The secondary authentication may be performed in many ways, which methods are per se known in the art. For example, it is envisaged that the POS authentication module 34 has the secondary authentication performed by a computer a bank responsible for an underlying bank account or by the computer system 2. The secondary authentication is known per se as aforementioned and therefore requires not to be described in detail. It is of relevance that the POS system receives confirmation of authentication or payment.

Another series of steps and messages is related to the data assembly according to the present invention. Prior to said authentication, in parallel thereto or after said authentication, the POS system or billing system 32 of the POS system transmits data required for the data assembly through step 130 to a data assembly compile module 38 of the POS system by means of message 131. The data assembly compile module 38 receives the message 131 and, based on this, compiles the data assembly in step 132. In step 134, the data assembly compile module 38 sends the data assembly to the POS transaction module 36 by means of message 135. In step 136, the POS receives transaction module 36 for the data assembly. In step 138, the POS transaction module 36 prepares message 139. Message 139 is composed of prior art transaction data, such as said transaction amount, date, data related to the Merchant as well as from the data assembly wherein the data assembly includes said data of details of the transaction.

Preferably, the data assembly comprises a full invoice of the transaction corresponding to the payment transaction. Alternatively, the data assembly comprises one or more invoice lines of such an invoice. It is hereby preferred that from the combined data of message 139 a complete invoice of the transaction corresponding to the payment transaction may be parsed, such as by the computer system 2 or the cardholder system 4. If no data assembly authorization is required with respect to the data assembly, but the data assembly merely serves to provide this information to the cardholder system, a separate transmission 138′ from the POS transaction module to computer system 2 or the processing module 22 thereof is provided by message 139′. In that case, the steps with regard to the data assembly authorization in the following are, of course, optional or not applicable.

Next, the message 139, such as including transaction data relating to the transaction, transaction authentication data relating to the transaction, such as relating to the cardholder, is received in step 140 by the computer system 2, such as from a transaction service provider or a payment service provider, such as by the transaction processing module 22 thereof. Upon receipt in the processing module 22 of the computer system 2, in step 142, by means of preferred data assembly receiving means, which are preferably executed as a process or sub-process by means of the transaction processing module, the data assembly from the message is distinguished from the data required according to the prior art for performing an authorization for execution thereof by the authorization module 24. A transaction processing module according to the prior art is, of course, arranged to receive said prior art transaction data, such as said transaction amount, the date, data relating to the Merchant. In addition to this, the data assembly receiving module provides, through steps 142, provides to the computer system 2 and its transaction processing module 22, the capability to receive the data assembly achieving these advantages of the present invention or preferred embodiments thereof.

Because of distinguishing the data assembly from the data required for the authorization according to the prior art, this authorization by the authorization module 24 is possible in a habitual manner according to the present invention. Subsequently, it is envisaged to process the data assembly after separating it within the purpose of the data assembly according to the present invention.

For the authorization according to the prior art, the processing module 22 sends a message 143 containing the necessary data to the authorization module 24. The authorization module 24 receives the necessary data, such as the authentication data and the amount of the transaction. Then, in step 144, the authorization module performs an authorization with respect to the transaction, wherein the authorization module performs this authorization based on a prior art authorization method. The result of the authorization of step 144 is transferred in step 146 via message 147 to the processing module 22. The processing module 22 executes the data assembly to data assembly parsing module 26 via message 151.

The data assembly parsing module 26 in step 152 parses the data assembly in order to separately analyze, process or store meaningful parts of the transaction in a database for later use of such information. The result is preferably stored directly in such a database by processing module 22. A direct advantage of this is that access to this information or use thereof is independent of a format of the data assembly. This is important because the data assembly is preferably communicated between the POS system and the computer system in a format that requires as few changes as possible to prior art communications between them. Further preferably, the data assembly is compiled into the POS system in a manner that requires as few adjustments as possible to the POS system, so that use of the data assembly is advantageously applicable as easily as possible in as many already used POS systems as possible with as few or as simple as possible adjustments to it. A possible result of this parsing includes, for example, a header record such as comprising an invoice number as well as records relating to invoice line content also specifying an individual invoice line that may be used for an authorization based on its content, whether or not in combination with for example the said location parameters or time parameters.

For the purpose of obtaining an authorization based on the content of the data assembly, the data assembly parsing module 26 provides by means of message 153 this content to the data assembly authorization module 28, which receives it in step 154. In step 156, the data assembly authorization module performs the authorization on at least one information unit from the data assembly, the authorization result of which is returned to processing module 22 for further forwarding to the POS system. By means of such authorization according to the present embodiment of the present invention, the quality of the authorization as a whole by the computer system 2 is significantly improved. The reason for this is that the authorization by the data assembly authorization module adds authorization aspects with regard to the content of the data assembly, whether or not in combination with authorization decision rules known per se. An important aspect of this is that authorization aspects that are important or determined by the cardholder may be taken into account. Decision rules used by the cardholder authorization module are provided at least in part in a foreseeable manner by the cardholder, such as by means of the cardholder system 4. By integrating such decision rules in the computer system 2 and specifically in the data compiling authorization module 28, such a data compiling authorization module is executable in real time, such as in parallel with the authorization by authorization module 24. This makes the data assembly authorization module executable with no or negligible delay compared to any authorization over the prior art. If the cardholder wants to keep decision rules with regard to the data assembly authorization in his own hands to a greater extent or wants to adapt it more flexibly by means of his own system, the preferred embodiment described below with modules 46, 48 may be used.

The result of the data assembly authorization is transferred by the data assembly authorization module 28 in step 156 via message 157 directly to the processing module 22, or alternatively (not shown) via the data assembly parsing module which forwards it to the processing module via step 158 and message 159 The processing module 22 receives the authorization result regarding the data assembly in step 156′. Alternatively, the processing module 22 receives the data assembly from the POS transaction module through step 140′ thereof through message 141′. This alternative is e.g. an option when the data compiling authorization is not required by the computer system 2 such as in the case where execution of the data compiling authorization is intended to be performed by the cardholder system 4 according to a respective preferred embodiment.

The processing module 22 outputs the prior art data assembly and transaction data in step 162 through message 163 to the cardholder system 4 such as the cardholder processing module 42 thereof. The relevant transaction data according to the prior art concerns data which according to the prior art is made available to the card holder in the form of an account statement, daily statements, monthly statement (statement of account). With the data as included in the data assembly, the cardholder thus advantageously has data directly at the time of the transaction on the basis of which the cardholder system may perform a data combination authorization by means of the cardholder authorization module. The cardholder is also hereby provided with data with which the cardholder may handle a declaration process vis-à-vis a third party in a very simple manner by means of the cardholder system. For example, in the case of a credit card, depending on the use of the credit card, it may easily be assumed that all payment transactions are handled by the cardholder system as an incoming expense report. Alternatively, the cardholder system may make a user interface available to the user 5 in which user interface the user 5 may indicate which elements of the data assembly are to be considered part of an expense report and which are not. Such manner of handling by the cardholder system is possible based on the use of the data assembly according to the present invention or a preferred embodiment thereof in relation to the transaction. It is further provided herein that such settlement by the cardholder system may be handled from a database functionality 44 of the cardholder system or from a further computer system that handles such settlement of a declaration as a service in favor of the cardholder.

The cardholder system 4 receives, preferably through cardholder processing module 42, the message 163 and in step 164 sends through message 165 the data assembly to cardholder data assembly parsing module 46. It parses the data assembly in step 166 for storage of elements thereof, as indicated in the manners indicated in relation to step 152. The result is preferably stored directly in a database 44 by transaction data processing module 42, similar to step 156. For the purpose of providing an authorization based on data content, the cardholder data assembly parsing module 46 provides in step 166 by means of message 167 to the cardholder authorization module 48.

This cardholder authorization module 48 receives the message 166 in step 168 and performs an authorization in step 170 in a similar manner or analogous to the authorization according to step 156. An advantage of the presence of the cardholder authorization module 48 in the cardholder system 4 is that the cardholder may keep confidential data related to such an authorization process within one's own system and may make adjustments flexibly. Important authorizations may for example be executed by means of a manual authorization within or linked to the cardholder system.

The result of the authorization is provided by the cardholder authorization module to the cardholder processing module 42 through message 171. Alternatively, an intermediate step is provided (not shown) via the cardholder data assembly parsing module.

The result of the authorization is transmitted in step 172 by the cardholder processing module of the cardholder system to the computer system 2 such as to its processing module 22 by means of message 173.

The computer system 2, such as by means of its processing module 22, supplies in step 174 the results of the authorizations with regard to the respective transaction to the POS system, such as its POS transaction module, by means of message 175. The authorization result may either be an authorization result originating from authorization module 24, which may originate from authorization module 28 or which may originate from authorization module 48. It is envisaged that the authorization result will often be a combination of the authorization result from authorization module 24 in combination with either of module 28 or 48. With this, the advantage is provided of an authorization based on all authorization expertise as contained in authorization module 24 with the addition of an authorization based on a data assembly authorization according to the present invention or a preferred embodiment thereof.

In a manner known per se, the authorization result received by the POS transaction module is used for processing the purchase of products and/or services between the Merchant and the cardholder. Hereby, the result of the authorization received by the POS system is fed back by means of step 176 by means of message 177 to the cardholder 5, who receives it in step 178, such as by reading it on a screen of the POS transaction module. Otherwise, the POS system handles the transaction as far as the result for the Merchant is concerned in a manner known per se.

A further aspect of step 172 concerns registration or storage of data relating to the transaction and/or authorization by the cardholder system 4. The relevant data is stored by the cardholder processing module in a database 44 for later use of the data.

An example of later use of such data is checking the data by the user. At step 180, the user makes a query regarding such data through message 181 to the cardholder processing module. The cardholder processing module receives this message 181 in step 182. In step 184, the cardholder processing module collects the requested data and makes it available via message 183 to the cardholder or third party. It is further envisaged that this communication process is used for the handling of bills by the third party in the cardholder system. For example, a third party holder may indicate whether or not certain items of the data assembly should form part of an declaration or be reimbursed. To this end, an alternative variant of step 184 displaying a suitable graphical user interface is provided.

Also provided is a maintenance interface for maintenance of the cardholder authorization module. The cardholder authorization module 48 is provided as a computer implementation for performing authorizations in real time. The envisaged preferred implementation of this is the execution of authorizations based on decision rules on the basis of which the authorizations may be executed in real time by the cardholder system. To this end, its cardholder authorization module comprises an interface for updating and/or maintaining the decision rules by means of steps 188 and 190. These steps include receiving the requests and displaying a user interface for handling the requests and receiving updates or maintenance of the decision rules or any further aspect of the cardholder authorization module.

FIG. 3 shows an example of an invoice associated with a payment transaction as an example of a transaction. The invoice shows various types of information underlying a transaction such as a payment transaction. An information element required for a payment transaction concerns the amount to be paid, which is shown on the invoice as invoice total 71. A date 72 relating to the transaction is furthermore shown. With regard to the cardholder or third-party holder, data are provided such as name and address data 75 in case a cash register system is set up for drawing up an invoice with such data, such as is of practical use for, for example, proofs as mentioned elsewhere in the specification of this document. Furthermore, data relating to the Merchant is shown on the invoice by means of name 73 and address 74. A further underlying data concerns the date of the transaction, which is also shown on the invoice as invoice date 72.

A POS system according to the prior art usually only needs to transfer the amount to be paid to the computer system 2 for the purpose of the transaction. The appropriate code under which the Merchant is known in the computer system 2. A date and time of the transaction is also required for the computer system 2. Such information is exchanged in a manner known per se between the POS system 3 and the computer system 2. In addition, the present invention provides a data assembly to be exchanged between the POS system 3 and the computer system 2. The invoice also contains invoice lines 77 relating to the purchased products and/or services, with associated names of data fields. This data is provided as contained in the data assembly.

To this end, the data assembly comprises data that form part of the invoice. Such data need not, for advantageous applicability thereof, comprise the entirety of the invoice data, but the advantage of transferring data on the basis of which a complete, as legally valid, invoice may be regarded as having been transferred is preferred for advantageous applicability. If the data assembly, whether or not in combination with the other transaction data, may be regarded as a fully legally valid invoice, the advantage of the said declaration on the basis of the data assembly may be obtained. Such a fully valid invoice transmitted according to the technical features according to preferred embodiments of the present invention therefore provides the advantage that the cardholder or third-party holder no longer needs to keep and provide such documentation to the cardholder. It is particularly advantageous here that each payment transaction may be provided with a data assembly providing the complete invoice with regard to the payment transaction, whereby this invoice is included within payment transaction communication of the POS system 3 and the computer 2 of the payment service provider.

But also if only parts of the data as shown on the invoice are included in the data assembly, this provides advantageous possibilities. The possibility of data assembly authorization is executable on the basis of information relating to individual products or services with the associated price, possibly in combination with the date, in line with the above description.

Furthermore, in the case that only parts of this data, a simplification of the processing of declarations by the cardholder system is possible because on the basis of this information with regard to individual products or services, a cardholder or third-party holder may indicate via the said user interface which of these are billable costs and which are not.

FIG. 4 shows a further example of an invoice as associated with a payment transaction as an example of a transaction. This concerns the purchase of a travel service comprising a ticket and twee surcharges. The format of the invoice is otherwise similar to the format of that according to FIG. 3. The data assembly authorization based on these products and services gives the cardholder additional options for the authorization compared to a simple positive or negative authorization based on the service and the price. In the decision rules, functionality may be added that takes into account parameters about the service that make the price higher or lower. An airline ticket shortly before departure is often more expensive than an airline ticket that is booked several months before departure. If a third-party holder suddenly has to purchase such a ticket for the benefit of the card holder, such urgency and its influence on a price and an acceptability thereof may be taken into account. For example, with regard to surcharges. Restrictions are used in the decision rules regarding the amount of baggage.

FIG. 5 shows a further example of an invoice associated with a payment transaction as an example of a transaction. This concerns a hotel stay. The layout of the invoice is further similar to the layout of that according to FIG. 3. Price variations also apply to such a service depending on the time parameter, but also price variations depending on the luxury parameter. Each of such parameters is applicable, as mentioned above, in determining a data assembly authorization. Advantageously, such parameters may be included in decision rules for automatic authorization by the cardholder system.

A POS system according to application in the present invention relates to an electronic POS system which is adapted to process a payment transaction. To this end, such a POS system is suitable for communicating electronically with the computer system, such as payment transaction system, such as is operational at, for example, a credit card company for processing payment transactions based on a credit card issued by them or authentication related to such a credit card or an associated account.

The steps indicated in the specification or the appended claims are described in a particular order for purposes of illustration. The order as described is not described as a limiting order. The person skilled in the art recognizes within the description of this document a variety of technical possibilities free to interpret this sequence differently or to deem it feasible. Such an alternative sequence understood by those skilled in the art within the description of this document is therefore also disclosed.

A module as indicated in the foregoing may be a functional module executed as a processing process on a general processing unit that also executes other modules. Such a module can, however, also be embodied by means of separate hardware. A computer system according to the foregoing description may be a single machine or may be implemented as several machines, virtual machines or hardware machines. A database as referred to above may be implemented as a process within a computer or machine, but may also be implemented through a separate computer or server.

The present invention is described in the foregoing on the basis of preferred embodiments. Different aspects of different embodiments are expressly considered disclosed in combination with each other and in all combinations that on the basis of this document, when read by a skilled person of the area of skill, fall within the scope of the invention or are deemed to be read with the disclosure of this document. These preferred embodiments are not limitative for the scope of protection of this document. The rights sought are defined in the appended claims.

1. Method for processing of a payment transaction by means of a processing (finalization) computer system (2), such as a payment transaction system, such as a credit card transaction system arranged at a credit card organization, arranged for processing of the payment transaction, such as a credit card payment transaction, initiated at a POS system (3), such as arranged at a merchant, the method comprising steps of:
processing of payment transaction information, such as comprising an amount to be paid with respect to the transaction, from the POS system (3), such as from a transaction module thereof,
receiving of authentication information (140) with respect to the transaction, from the POS system (3),
transmitting (174) of authorization confirmation information relating to a confirmation of an authorization of the transaction to the POS system (3), characterized by steps for:
receiving (142), such as by means of a data assembly receipt module such as by means of a process executed on a processing unit, of a data assembly comprising specification information relating to the transaction from the POS system (3).

2. Method according to claim 1 comprising steps of parsing (152), such as by means of a data assembly parsing module (26), of the data assembly comprising specification information (76) with respect to the transaction from the POS system (3).

3. Method according to claim 1 wherein the steps of receiving of the data assembly comprise steps of receiving of the data assembly from a transaction module or a data assembly compile module (38), of the POS system (3).

4. Method according to one or more of the preceding claims wherein the steps for receiving of the data assembly comprise steps for receiving of the data assembly from a cash register device or invoicing system (5) of the POS system (3).

5. Method according to one or more of the preceding claims comprising data assembly authorization steps (154) based on at least a part of the data assembly providing an authorization grant or an authorization denial, preferably comprising steps of compiling of the authorization confirmation information, such as by means of a data assembly authorization module (28), in case of granting of authorization based on the data assembly.

6. Method according to claim 5 comprising steps for, such as by means of the data assembly authorization module (28), executing of the data assembly authorization steps (154) based on at least a part of the data assembly based on decision rules.

7. Method according to one or more of the preceding claims comprising steps of transmitting of the payment transaction information and preferably the data assembly to a cardholder processing system (4), such as received from the POS system or such as parsed by means of a data assembly parsing module (26) of the computer system.

8. Method according to one or more of the preceding claims comprising steps of receiving, such as by means of a data assembly authorization module (28), of a cardholder transaction authorization of the transaction based on the transaction information and/or the data assembly from the cardholder processing system (4), preferably from a cardholder authorization module (48) thereof.

9. Method according to one or more of the preceding claims wherein the data assembly is functional as a proof of access, such as a ticket, such as for access to a concert, transport, such as a train or plane.

10. Method according to one or more of the preceding claims wherein the data assembly is functional as proof of access to spaces, services or as a further resource.

11. Method according to one or more of the preceding claims wherein the data assembly is functional as a proof of warranty, proof of ownership, proof of insurance, a proof of delivery in parts and/or on call.

12. Method according to one or more of the preceding claims wherein the data assembly is functional as an input for a process step of a series of processing steps, such as in a block chain process.

13. Method according to one or more of the preceding claims wherein the data assembly is functional for a company purchasing transaction, such as by means of a purchasing card.

14. Method for processing by means of a POS system (3) of a payment transaction with a computer system (2), such as a payment transaction system, such as a credit card transaction system arranged at a credit card company, arranged for processing of the transactions, such as a credit card payment transaction, of the payment transaction for transmitting to the computer system (2), the method comprising steps of:
transmitting of transaction information, such as comprising an amounts to be paid with respect to the transaction, from the POS system (3),
transmitting of authentication information with respect to the transaction from the POS system (3),
receiving of confirmation information with respect to a confirmation of an authorization of the transaction to the POS system (3), characterized by steps of:
compiling, such as by means of a data assembly compile module of a data assembly comprising specification information relating to the transaction of the POS system (3).

15. Method according to claim 14 wherein the steps of transmitting of the data assembly comprise steps of transmitting of the data assembly from a transaction module or the data assembly compile module of the POS system (3) to the computer system (2), such as by means of a data assembly receiving module thereof.

16. Method according to claim 14 wherein the steps of transmitting of the data assembly comprise steps of transmitting of the data assembly from a cash register device or invoicing system (5) of the POS system (3) to the computer system (2).

17. Method according to claim 14, wherein the compiling steps provide information with respect to elements of the purchase of products and/or services underlying to the transaction in a predetermined data format, such as in a substantially character-based format HTML, XBRL, SWIFT, ASCII, CSV, PDF, or in a substantially graphically based format such as JPG or TIFF.

18. Method for processing by means of a cardholder processing system (4) of a payment transaction with a computer system (2), such as a payment transaction system, such as a credit card transaction system arranged at a credit card company, arranged for processing of the payment transaction, such as a credit card payment transaction, of the transaction for transmitting to the computer system (2), the method comprising steps of:
receiving of payment transaction information, such as comprising an amount to be paid with regard to the transaction, from the computer system (2), characterized by:
receiving (160), such as by means of a data assembly receipt module, such as by means of a process executed on a processing unit, of a data assembly comprising specification information relating to the transaction.

19. Method according to claim 18 wherein the steps of receiving of a data assembly comprising specification information with respect to the transaction from the computer system (2) or the POS system (3).

20. Method according to claim 18 or 19 comprising data assembly authorization steps (166), such as by means of the cardholder authorization module (48), based on at least a part of the data assembly providing an authorization grant or authorization denial, preferably comprising steps of compiling of the confirmation information in case of granting of the authorization based on the data assembly.

21. Method according to claim 18, 19, 20 or 21, comprising steps of performing the cardholder authorization steps and/or the data assembly authorization steps based on at least a part of the data assembly based on decision rules.

22. Computer system (2), such as a payment transaction system, such as a credit card transaction system arranged at a credit card company, arranged for processing of a payment transaction, such as a credit card payment transaction, for processing (finalizing) of the payment transaction from a POS system (3), such as arranged with a merchant, the computer system (2) comprising:
at least one processing unit arranged for data processing,
at least one data store for storage of instructions and/or data,
a receipt module arranged for receiving of payment transaction information, such as comprising an amount to be paid with respect to the transaction, from the POS system (3),
a receipt module arranged for receiving of authentication information with respect to the transaction, from the POS system (3),
a transmit module arranged for transmitting of authorization information with respect to an authorization of the transaction to the POS system (3), characterized by:
a data assembly receipt module, such as a process performed on a processing unit, for the purpose of receiving (142), for receiving of a data assembly comprising specification information with respect to the transaction from the POS system (3).

23. Computer system according to claim 22 comprising a data assembly parsing module (26) arranged for parsing of a data assembly comprising the specification information with respect to the transaction from the POS system (3).

24. Computer system according to claim 22 or 23 comprising a data assembly authorization module (28) for performing of data assembly authorization steps (154) providing an authorization grant or an authorization denial based on at least a part of the data assembly, preferably on the basis of decision rules.

25. Computer system according to claim 18 further arranged for executing steps according to one or more of the claims 1-13.

26. POS system (3) for processing of a transaction with a computer system (2), such as a payment transaction system, such as a credit card transaction system arranged at a credit card company, arranged for processing of a payment transaction or an authorization transaction, such as a credit card payment transaction, for transmitting to the computer system (2), comprising:
a transmit module arranged for transmitting of payment transaction information, such as comprising an amount to be paid with respect to the transaction, from the POS system (3),
a transmit module arranged for transmitting of authentication information with respect to the transaction, from the POS system (3),
a receipt module device for receiving of confirmation information with respect to a confirmation of an authorization of the transaction to the POS system (3), characterized by steps of:
a data assembly compile module arranged for transmitting of a data assembly comprising specification information with respect to the transaction from the POS system (3).

27. POS system according to claim 26 wherein the transmit module arranged for transmitting of the payment transaction information and/or the transmit module arranged for transmitting of authentication information are a component or function of a payment terminal.

28. POS system according to claim 20 further arranged for performing of steps according to one or more of the claims 14-17.

29. Cardholder processing system (10) or cardholder authorization system for processing of a payment transaction with a computer system (2), such as a payment transaction system, such as a credit card transaction system arranged at a credit card company, arranged for processing of the payment transaction, such as a credit card payment transaction, for transmitting to the computer system (2), comprising:
a receipt module arranged for receiving of payment transaction information, such as comprising an amount to be paid with respect to the transaction, from the computer system (2), characterized by:
a data assembly receipt module, such as a process executed at a processing unit, for the purpose of receiving (162) of a data assembly comprising specification information with respect to the transaction from the computer system (2) and/or the POS system (3).

30. Cardholder processing system (10) according to claim 29 comprising a cardholder authorization module (48) for executing of data assembly authorization steps (166) providing an authorization grant or an authorization denial based on at least a part of the data assembly, preferably executed based on decision rules.

31. Cardholder processing system according to one or more of the claims 29-30 wherein the cardholder authorization module is arranged for executing of cardholder authorization steps and/or data assembly authorization steps based on at least a part of the data assembly executed based on decision rules.

32. Data message generated with application of a method for processing of a payment transaction by means of a POS system (3), the data message comprising transaction information with respect to the payment transaction, such as a payment transaction or authorization transaction for execution thereof by a computer system (2), such as a payment transaction system, such as a credit card transaction system arranged at a credit card company, arranged for processing of the payment transaction, such as a credit card payment transaction, the method comprising steps of:
processing of transaction information, such as comprising an identification of a cardholder and an amount to be paid with respect to the transaction, preferably combined with a transaction date,
compiling of a data assembly comprising specification information with respect to the transaction,
assembling of the data message comprising the transaction information at the data assembly in a format suitable for receipt by the computer system (2).

33. Data message according to claim 32 further compiled with application of method steps for gathering authentication information with respect to the transaction as well as steps for adding of the authentication information to the data message.

34. Data message according to claim 32 or 33 wherein the steps for compiling of the data message comprises steps for: forming of the data message to a standard for payment transaction communication with a payment terminal.
